(19) United States
(12) Patent Application Publication
(10) Pub. No.: US 2012/0055267 A1
(43) Pub. Date: Mar. 8, 2012

(54) PRESSURE SENSOR

(75) Inventor: Kenta SATO, Kamiina (JP)

(73) Assignee: SEIKO EPSON CORPORATION, Tokyo (JP)

(21) Appl. No.: 13/179,992

(22) Filed: Jul. 11, 2011

(30) Foreign Application Priority Data
Sep. 7, 2010 (JP) 2010-200055

(51) Int. Cl. G01L 1/00

(52) U.S. Cl. 73/862.381

(57) ABSTRACT

A pressure sensor includes a container; a pressure receiving member which constitutes a part of the container; a supporting member which extends from a peripheral portion of the pressure receiving member in parallel to the displacement direction of the pressure receiving member, and in which an end portion thereof is bent toward a central portion of the pressure receiving member; and a pressure sensing device which has a pressure sensing portion and first and second base portions respectively connected to both ends of the pressure sensing portion. The supporting member includes two or more members which are formed of different materials and connected in the displacement direction, and the proportion of the lengths of the two or more members is adjusted so that the supporting member has the same thermal expansion coefficient as the pressure sensing device.

### BACKGROUND

1. Technical Field

The invention relates to a pressure sensor having a pressure sensing device and a diaphragm, and more particularly, to a pressure sensor capable of reducing measurement errors due to a change in temperature.

2. Related Art

JP-A-2010-19826 and JP-A-2010-48798 disclose pressure sensors that use a piezoelectric vibrator as a pressure sensing device.

FIG. 7 is a schematic view of a pressure sensor disclosed in JP-A-2010-19826. A pressure sensor 340 of JP-A-2010-19826 includes a hollow cylindrical housing 342 which includes a flange endplate 344, a hermetic terminal block 346, and a cylindrical side wall 348. First and second diaphragms 350 and 352 are hermetically attached to the openings of the flange endplate 344 and the hermetic terminal block 346. A center shaft 354 is disposed inside the housing 342 so as to connect the central areas of the inner surfaces of the first and second diaphragms 350 and 352. Moreover, a plurality of supporting rods 362a and 362b is disposed around and in parallel to the center shaft 354. A movable portion 356 serving as a pressure sensing device pedestal is provided integrally with the intermediate portion of the center shaft 354. The movable portion 356 is attached to one end portion of a pressure sensing device 358 that is formed of a double-ended tuning fork vibrator in which the detection axis is parallel to an axis vertical to the pressure receiving surfaces of the diaphragms 350 and 352. Moreover, the other end portion of the pressure sensing device 358 is connected to a boss portion 360 of the hermetic terminal block 346. With this configuration, the center shaft 354 moves in the axial direction due to the pressure difference between the first diaphragm 350 for receiving pressure and the second diaphragm 352 for setting atmospheric pressure. Following the movement, the movable portion 356 is displaced, and the displacement force generates the force acting on the pressure sensing device 358 in the detection axis direction.

FIG. 8 is a schematic view of the pressure sensor disclosed in JP-A-2010-48798. A pressure sensor 410 of JP-A-2010-48798 includes a housing 412, a diaphragm 424 which seals an opening 422 of the housing 412 and includes a flexible portion and a peripheral region 424c positioned on the outer side of the flexible portion, and in which one principal surface of the flexible portion is a pressure receiving surface, and a pressure sensing device 440 which includes a pressure sensing portion and first and second base portions 440a and 440b respectively connected to both ends of the pressure sensing portion, and in which an arrangement direction of the first and second base portions 440a and 440b is parallel to a displacement direction of the diaphragm 424. In the pressure sensor 410, the first base portion 440a is connected to a central portion of the diaphragm 424, which is the rear side of the pressure receiving surface, and the second base portion 440b is connected to the peripheral region 424c on the rear side, or to an inner wall of the housing 412 facing the first base portion 440a, through a connecting member 442.

With this configuration, the first base portion 440a disposed at one end in the detection axis direction of the pressure sensing device 440 is connected to the central portion of the diaphragm 424 which is displaced by pressure from the outside. The second base portion 440b disposed at the other end on the opposite side of the one end is connected to the peripheral region 424c of the diaphragm 424, which is fixed to the housing 412 and is not displaced by pressure from the outside, or to the inner wall of the housing 412 facing the first base portion 440a, through the connecting member 442. Therefore, the pressure sensor 410, in which the pressure sensing device 440 receives compressive stress due to pressure from the outside, measures absolute pressure. Moreover, since the both ends of the pressure sensing device 440 are connected to the side of the diaphragm 424, it is possible to reduce pressure measurement errors accompanied by a change in temperature resulting from a difference in the linear expansion coefficients of the pressure sensing device 440 and the housing 412 which are formed of different materials. Furthermore, by forming the pressure sensing device 440 integrally with the connecting member 442 using a piezoelectric material, thermal deformation between the pressure sensing device 440 and the connecting member 442 can be prevented. Thus, it is possible to reduce pressure measurement errors.

However, in the pressure sensor 340 of JP-A-2010-19826, when there are temperature changes since thermal deformation is applied to the pressure sensing device due to a difference in the thermal expansion coefficients of the pressure sensing device and the center shaft 354, the resonance frequency of the pressure sensor changes, which makes it difficult to measure pressure accurately.

Moreover, in the pressure sensor 410 of JP-A-2010-48798, it is possible to prevent the occurrence of thermal deformation in the detection axis direction of the pressure sensing device 440. However, since the connecting member 442 and the diaphragm 424 are formed of different materials, thermal deformation occurs between the diaphragm 424 and a portion of the connecting member 442 extending in a direction vertical to the detection axis direction of the pressure sensing device 440. Moreover, since the connecting member 442 receives the thermal deformation, the pressure sensing device 440 receives the thermal deformation from the connecting member 442. Thus, it is not possible to sufficiently eliminate the effect of thermal deformation.

### SUMMARY

An advantage of some aspects of the invention is that it provides a pressure sensor capable of suppressing thermal deformation of a pressure sensing device resulting from a container and a diaphragm.

### Application Example 1

This application example is directed to a pressure sensor including: a container; a pressure receiving member which constitutes a part of the container and is displaced toward the inner side or the outer side of the container in response to a force; a supporting member which extends from a peripheral portion of the pressure receiving member in parallel to the displacement direction of the pressure receiving member, and in which an end portion thereof is bent toward a central portion of the pressure receiving member; and a pressure sensing device which has a pressure sensing portion and first and second base portions respectively connected to both ends of the pressure sensing portion, in which an arrangement direction of the first and second base portions is parallel to the displacement direction of the pressure receiving member, the first base portion is fixed to the central portion of the pressure receiving member, and the second base portion is fixed to the supporting member, wherein the supporting member includes two or more members which are formed of different materials and connected in the displacement direction, and the proportion of the lengths of the two or more members is adjusted so that the supporting member has the same thermal expansion coefficient as the pressure sensing device.

With this configuration, since the base portions at both ends of the pressure sensing device are connected to the side of the pressure receiving member, it is possible to suppress thermal deformation of the pressure sensing device resulting from the container. Moreover, since the supporting member has the same thermal expansion coefficient as the pressure sensing device, even when a change in length such as a thermal expansion occurs in the supporting member and the pressure sensing device due to a change in temperature, it is possible to make the rates of elongation substantially identical. Thus, it is possible to provide a pressure sensor in which thermal deformation applied to the pressure sensing device is suppressed and pressure measurement errors due to a change in temperature are suppressed.

### Application Example 2

In the pressure sensor of the above application example, one of the two or more members may be formed of the same material as the pressure receiving member, and the other member may be formed of a material having a lower thermal expansion coefficient than the pressure sensing device when the thermal expansion coefficient of the material of the pressure receiving member is higher than the thermal expansion coefficient of the material of the pressure sensing device, and may be formed of a material having a higher thermal expansion coefficient than the pressure sensing device when the thermal expansion coefficient of the material of the pressure receiving member is lower than the thermal expansion coefficient of the material of the pressure sensing device.

The pressure receiving member may be formed of a material having a lower thermal expansion coefficient than the material of the pressure sensing device, one of the two or more members may be formed of the same material as the pressure receiving member, and the other member may be formed of a material having a higher thermal expansion coefficient than the pressure sensing device.

The pressure receiving member may be formed of a material having a higher thermal expansion coefficient than the material of the pressure sensing device, one of the two or more members may be formed of the same material as the pressure receiving member, and the other member may be formed of a material having a lower thermal expansion coefficient than the pressure sensing device.

With this configuration, by using two or more members having higher or lower thermal expansion coefficient than the material of the pressure sensing device, it is easy to adjust the proportion of the lengths of the members so as to make the thermal expansion coefficients of the supporting member and the pressure sensing device identical.

### Application Example 3

In the pressure sensor of the above application example, the pressure sensing device may be formed of a quartz crystal, and the pressure receiving member may be formed of stainless steel.

With this configuration, by forming the pressure receiving member using stainless steel, it is possible to provide a pressure receiving member having high pressure sensitivity while having sufficient rigidity. Moreover, by forming the pressure sensing device using a quartz crystal, it is possible to reduce manufacturing costs.

### Application Example 4

This application example is directed to a pressure sensor including: a container; a pressure receiving member which constitutes a part of the container and is displaced toward the inner side or the outer side of the container in response to a force; a supporting member which extends from a peripheral portion of the pressure receiving member in parallel to the displacement direction of the pressure receiving member, and in which an end portion thereof is bent toward a central portion of the pressure receiving member; and a pressure sensing device which has a pressure sensing portion and first and second base portions respectively connected to both ends of the pressure sensing portion, in which an arrangement direction of the first and second base portions is parallel to the displacement direction of the pressure receiving member, the first base portion is fixed to a supporting block of the pressure receiving member, and the second base portion is fixed to the supporting member, wherein the supporting member and the supporting block include two or more members which are formed of different materials, and the proportion of the lengths of the two or more members is adjusted so that the supporting member and the supporting block have the same thermal expansion coefficient as the pressure sensing device.

With this configuration, since the base portions at both ends of the pressure sensing device are finally connected to the side of the pressure receiving member, it is possible to suppress thermal deformation of the pressure sensing device resulting from the container. Moreover, since the supporting member and the supporting block have the same thermal expansion coefficient as the pressure sensing device, even when a change in length such as a thermal expansion occurs in the supporting member and the supporting block due to a change in temperature, it is possible to make the rates of elongation substantially identical. Thus, it is possible to provide a pressure sensor in which thermal deformation applied to the pressure sensing device is suppressed and pressure measurement errors due to a change in temperature are suppressed.

### Application Example 5

In the pressure sensor of the above application example, another set of the pressure receiving member, the pressure sensing device, and the supporting member may be arranged in the container.

With this configuration, since a plurality of pressure receiving members can be formed in one container, a pressure sensor in which the pressure sensing device and the supporting member are provided to each pressure receiving member can be obtained. Thus, it is possible to obtain a pressure sensor in which two pressure sensing devices are located within the same container, and which can measure an accurate pressure difference between the different amounts of pressure applied to the respective pressure receiving members.

### BRIEF DESCRIPTION OF THE DRAWINGS

The invention will be described with reference to the accompanying drawings, wherein like numbers reference like elements.

FIG. 1 is a perspective cross-sectional view of a pressure sensor according to a first embodiment, taken along the XZ plane.

FIGS. 2A and 2B are cross-sectional views of the pressure sensor according to the first embodiment, taken along the XZ and YZ planes, respectively.

FIG. 3 is a graph showing the relationship between the proportion of a first member and temperature property.

FIG. 4 is a perspective cross-sectional view of a pressure sensor according to a second embodiment, taken along the XZ plane.

FIG. 5 is a perspective cross-sectional view of a pressure sensor according to a third embodiment, taken along the XZ plane.

FIG. 6 is a schematic view of a pressure sensor according to a fourth embodiment.

FIG. 7 is a schematic view of a pressure sensor disclosed in JP-A-2010-19826.

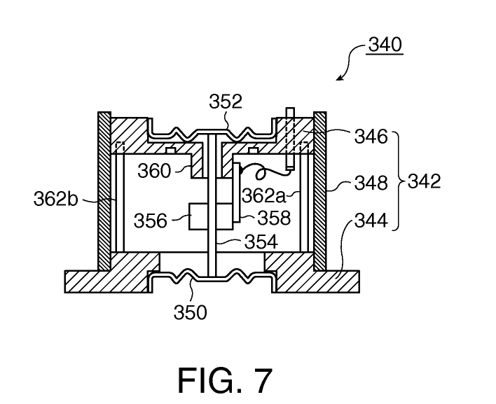

FIG. 8 is a schematic view of a pressure sensor disclosed in JP-A-2010-48798.

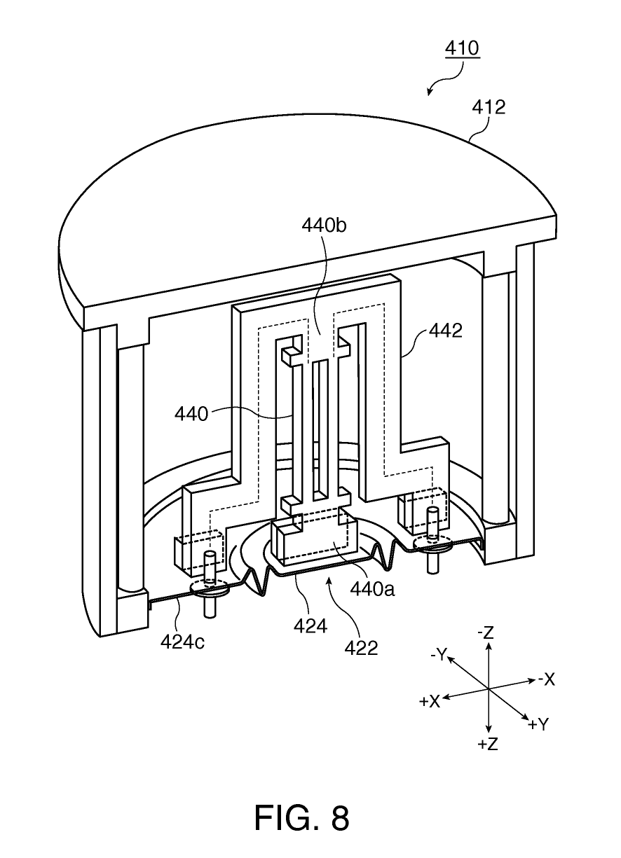

### DESCRIPTION OF EXEMPLARY EMBODIMENTS

Hereinafter, embodiments of a pressure sensor according to the invention will be described in detail with reference to the accompanying drawings.

### First Embodiment

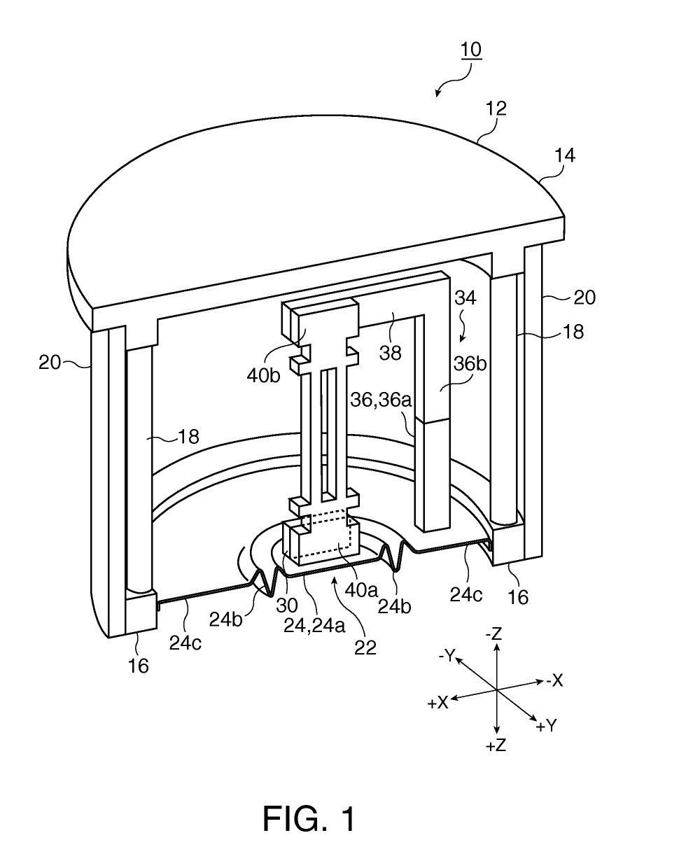

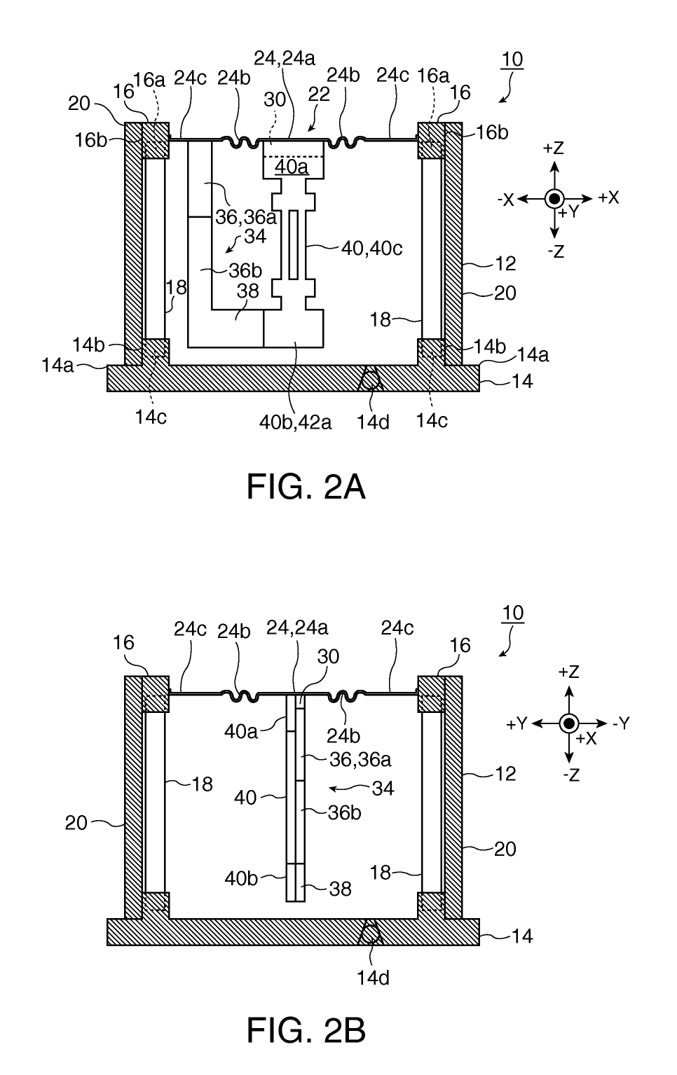

FIG. 1 is a perspective cross-sectional view of a pressure sensor according to a first embodiment, taken along the XZ plane. FIGS. 2A and 2B are cross-sectional views of the pressure sensor according to the first embodiment, taken along the XZ and YZ planes, respectively. Here, the X, Y, and Z axes shown in FIGS. 1, 2A, and 2B constitute an orthogonal coordinate system, and the same is applied to the drawings referred to hereinafter. A pressure sensor 10 according to the first embodiment includes a housing 12 and a diaphragm 24 which serve as a container. A supporting member 34, a pressure sensing device 40, and the like are accommodated in the accommodation space of the container having the diaphragm 24. Moreover, when the inside of the housing 12 is opened to the atmosphere, for example, the pressure sensor 10 can be used as a fluid pressure sensor that receives fluid pressure from outside the diaphragm 24 with reference to atmospheric pressure. Moreover, when the inside of the housing 12 is vacuum-sealed, the pressure sensor 10 can be used as an absolute pressure sensor with reference to vacuum.

The housing 12 includes a circular flange portion 14, a circular ring portion 16, a supporting shaft 18, and cylindrical side surfaces (side walls) 20. The flange portion 14 includes an outer peripheral portion 14a that is in contact with the end portions of the cylindrical side surfaces (side walls) 20 and an inner peripheral portion 14b that is formed on the outer peripheral portion 14a to be concentric to the outer peripheral portion 14a so as to protrude in a ring shape having the same diameter as the ring portion 16. The ring portion 16 includes a circular opening 22 which is formed by the inner peripheral edge thereof. The diaphragm 24 is connected to the opening 22 so as to seal the opening 22, and the diaphragm 24 constitutes a part of the housing 12. Holes 14c and 16a in which supporting shafts 18 are inserted are formed at predetermined positions of the inner peripheral portion 14b of the flange portion 14 and the mutually facing surfaces of the ring portion 16. Moreover, the holes 14c and 16a are formed at the mutually facing positions. Therefore, when the supporting shafts 18 are inserted into the holes 14c and 16a, the flange portion 14 and the ring portion 16 are connected by the supporting shafts 18. The supporting shafts 18 are rod-like members having predetermined rigidity and extending in the ±Z direction. The supporting shafts 18 are disposed inside the container which includes the housing 12 and the diaphragm 24. When one ends of the supporting shafts 18 are inserted into the holes 14c of the flange portion 14 and the other ends thereof are inserted into the holes 16a of the ring portion 16, predetermined rigidity is obtained between the flange portion 14, the supporting shafts 18, and the ring portion 16. Although a plurality of supporting shafts 18 is used, the arrangement thereof is optional depending on the design of the positions of the respective holes.

Moreover, hermetic terminals (not shown) are attached to the flange portion 14. The hermetic terminals are configured to be capable of electrically connecting electrode portions (not shown) of the pressure sensing device 40 described later and an integrated circuit (IC: not shown) through wires (not shown). The IC is used for oscillating the pressure sensing device 40 and is attached to the outer surface of the housing 12 or is disposed outside the housing 12 to be separated from the housing 12. When the pressure sensor 10 is used as the fluid pressure sensor described above, an air inlet opening 14d is formed on the flange portion 14 so that the inside of the housing 12 can be opened to the atmosphere. Since both ends of the side surfaces 20 are respectively connected to the outer periphery of the inner peripheral portion 14b of the flange portion 14 and the outer periphery 16b of the ring portion 16 of which the opening 22 is covered by the diaphragm 24, the container is sealed. The flange portion 14, the ring portion 16, and the side surfaces 20 are preferably formed of metal such as stainless steel. The supporting shafts 18 are preferably formed of ceramics or the like having predetermined rigidity and a low thermal expansion coefficient.

One principal surface of the diaphragm 24 facing the outer surface of the housing 12 is configured as a pressure receiving surface. The pressure receiving surface has a flexible portion which is bent and deformed in response to pressure of a pressure measurement environment (for example, liquid). When the flexible portion is bent and deformed to be displaced toward the inner or outer side (Z-axis direction) of the housing 12, the diaphragm 24 transmits a Z-axis direction compressive or tensile force to the pressure sensing device 40. Moreover, the diaphragm 24 includes a central portion 24a that is displaced by pressure from the outside, a flexible portion 24b that is disposed on the outer periphery of the central portion 24a so as to be bent and deformed by the pressure from the outside so as to allow the displacement of the central portion 24a, and a peripheral portion 24c that is disposed on the outer side of the flexible portion 24b, namely on the outer periphery of the flexible portion 24b and is bonded and fixed to the inner wall of the opening 22 formed in the ring portion 16. Ideally, the peripheral portion 24c and the central portion 24a are not displaced even when pressure is applied thereto. The surface of the central portion 24a of the diaphragm 24 on the opposite side of the pressure receiving surface is connected to one end (first base portion 40a) in the longitudinal direction (detection axis direction) of the pressure sensing device 40 described later. The diaphragm 24 is preferably formed of a material having excellent corrosion resistance such as metal (for example, stainless steel) or ceramics. For example, when the diaphragm 24 is formed of metal, it may be formed by pressing a base metal material. In addition, the surface of the diaphragm 24 exposed to the outside may be coated with an anti-corrosion film so as not to be corroded by liquids, gases, or the like. For example, if the diaphragm 24 is formed of metal, the diaphragm 24 may be coated with a nickel compound. A supporting block 30 and a supporting member 34 described later are respectively connected to the central portion 24a and the peripheral portion 24c of the diaphragm 24. The first base portion 40a of the pressure sensing device 40 is connected to the supporting block 30 that is connected to the central portion 24a. In addition, the supporting block 30 of the first embodiment is formed of the same material as the diaphragm 24 serving as a pressure receiving member. That is, the supporting block 30 is formed of a material having excellent corrosion resistance such as metal (for example, stainless steel) or ceramics.

The supporting member 34 includes a supporting column 36 and a supporting portion 38. The supporting member 34 is formed by two or more members including a member formed of the same material as the diaphragm 24 serving as the pressure receiving member. The supporting column 36 is in contact with the peripheral portion 24c of the diaphragm 24 so as to extend in parallel to the displacement direction (Z-axis direction) of the diaphragm 24. The supporting column 36 is formed by connecting two or more members (for example, first and second members 36a and 36b) formed of different materials in the displacement direction. Among the first and second members 36a and 36b, the second member 36b is formed of the same material as the diaphragm 24. That is, the second member 36b is formed of a material having excellent corrosion resistance such as metal (for example, stainless steel) or ceramics. In the supporting member 34 in which the supporting column 36 extending in the Z-axis direction includes two or more members, the proportion of the lengths of the first and second members 36a and 36b is adjusted so that the supporting member 34 has the same thermal expansion coefficient as the pressure sensing device 40. Moreover, the second member 36b of the two or more members is formed of the same material as the diaphragm 24. On the other hand, the first member 36a is formed of a material having a lower thermal expansion coefficient than the material of the pressure sensing device 40 when the material of the diaphragm 24 has a higher thermal expansion coefficient than the material of the pressure sensing device 40, and is formed of a material having a higher thermal expansion coefficient than the pressure sensing device 40 when the material of the diaphragm 24 has a lower thermal expansion coefficient than the material of the pressure sensing device 40. By using two or more members having a higher or lower thermal expansion coefficient than the material of the pressure sensing device 40, it is easy to adjust the proportion of the lengths of the members so as to make the thermal expansion coefficients of the supporting member 34 and the pressure sensing device 40 identical.

As an example of the thermal expansion coefficient, the thermal expansion coefficients of a quartz crystal, SUS316L, and SUS410 are 13.5, 16, and 11.0 (ppm/° C.), respectively. Therefore, when a quartz crystal is used for the pressure sensing device 40, SUS410 can be used as an example of stainless steel having a lower thermal expansion coefficient than the pressure sensing device 40. Moreover, SUS316L can be used as an example of stainless steel having a higher thermal expansion coefficient than the pressure sensing device 40.

The supporting portion 38 is bent in an L shape from the distal end of the supporting column 36 toward the central portion 24a of the diaphragm 24 so as to be connected to the second base portion 40b of the pressure sensing device 40. The supporting portion 38 shown in FIG. 1 is integrally formed by bending it at the distal end of the second member 36b. However, the supporting portion 38 may be formed by bending a separate member formed of the same material as the second member 36b at the distal end of the second member 36b. Moreover, the supporting member 34 shown in FIG. 1 is connected to the second base portion 40b of the pressure sensing device 40 in the side surface of the supporting portion 38. However, instead of this, the supporting column 36 may be formed on the ZY plane of the pressure sensing device 40 extending in the Z-axis direction so that the supporting member 34 is connected to the second base portion 40b in the end surface of the supporting portion 38. Furthermore, since the supporting portion 38 and the supporting column 36 constituting the supporting member 34 are formed by connecting rigid members such as stainless steel, these members have predetermined rigidity and will not be deformed even when the diaphragm 24 is deformed in response to pressure applied thereto.

The pressure sensing device 40 includes vibrating arms 40c serving as a pressure sensing portion and first and second base portions 40a and 40b which are formed at both ends of the vibrating arms 40c. The pressure sensing device 40 is formed of a piezoelectric material such as a quartz crystal, lithium niobate, or lithium tantalate. The first base portion 40a is connected to the side surface of the supporting block 30 and is in contact with the central portion 24a. Moreover, the second base portion 40b is connected to the distal end (end portion) of the supporting portion 38 of the supporting member 34. Furthermore, the pressure sensing device 40 includes excitation electrodes (not shown) which are formed on the vibrating arms 40c and the electrode portions (not shown) which are electrically connected to the excitation electrodes (not shown) . Therefore, the pressure sensing device 40 is disposed so that the longitudinal direction (Z-axis direction) thereof, namely the arrangement direction of the first and second base portions 40a and 40b is coaxial to or parallel to the displacement direction (Z-axis direction) of the diaphragm 24, and the displacement direction thereof is used as the detection axis. Moreover, since the pressure sensing device 40 is fixed by the supporting block 30 and the supporting member 34, the pressure sensing device 40 will not be bent in directions other than the detection axis direction even when it receives a force generated by the displacement of the diaphragm 24. Therefore, it is possible to prevent the pressure sensing device 40 from moving in directions other than the detection axis direction and to suppress a decrease in the sensitivity in the detection axis direction of the pressure sensing device 40.

The pressure sensing device 40 is electrically connected to the IC (not shown) through the hermetic terminals (not shown) and the wires (not shown) and vibrates at a natural resonance frequency in response to an alternating voltage supplied from the IC (not shown). Moreover, the resonance frequency of the pressure sensing device 40 changes when it receives extensional stress or compressive stress from the longitudinal direction (Z-axis direction) thereof. In the present embodiment, a double-ended tuning fork vibrator can be used as the vibrating arms 40c serving as the pressure sensing portion. The double-ended tuning fork vibrator has characteristics such that the resonance frequency thereof changes substantially in proportion to tensile stress (extensional stress) or compressive stress which is applied to the two vibrating beams which are the vibrating arms 40c. Moreover, a double-ended tuning fork piezoelectric vibrator is ideal for a pressure sensor which has such an excellent resolution as to detect a small pressure difference since a change in the resonance frequency to extensional and compressive stress is very large as compared to a thickness shear vibrator or the like, and a variable width of the resonance frequency is large. In the double-ended tuning fork piezoelectric vibrator, the resonance frequency of the vibrating arm increases when it receives extensional stress, whereas the resonance frequency of the vibrating arm decreases when it receives compressive stress. In the present embodiment, the pressure sensing portion is not limited to one which has two rod-like vibrating beams, but a pressure sensing portion having one vibrating beam (single beam) may be used. If the pressure sensing portion (the vibrating arm 40c) is configured as a single-beam vibrator, the displacement thereof is doubled when the same amount of stress is applied from the longitudinal direction (detection axis direction) . Therefore, it is possible to obtain a pressure sensor which is more sensitive than one having a double-ended tuning fork vibrator. In addition, among the piezoelectric materials described above, a quartz crystal having excellent temperature property is preferred as the material of a piezoelectric substrate of a double-ended or single-beam piezoelectric vibrator.

In the present embodiment, both ends (the first and second base portions 40a and 40b) in the longitudinal direction of the pressure sensing device 40 are finally connected to the side of the diaphragm 24. With this configuration, it is possible to suppress thermal deformation transmitted to the pressure sensing device 40 from the housing 12. Furthermore, the pressure sensing device 40 and the supporting member 34 are formed so that they have the same thermal expansion coefficient by adjusting the proportion of the lengths of the first and second members 36a and 36b. Therefore, the pressure sensing device 40 and the supporting member 34 have the same proportion of the amounts of expansion and contraction in the detection axis direction due to a change in temperature. Accordingly, in response to expansion and contraction in the detection axis direction due to a change in temperature, the pressure sensing device 40 receives small thermal deformation from the supporting member 34. Moreover, since part of the members constituting the supporting member 34 is formed of the same material as the diaphragm 24 serving as the pressure receiving member, thermal deformation does not occur between the diaphragm 24 and a portion extending in a direction vertical to the detection axis direction of the pressure sensing device 40, and the pressure sensing device 40 does not receive the thermal deformation.

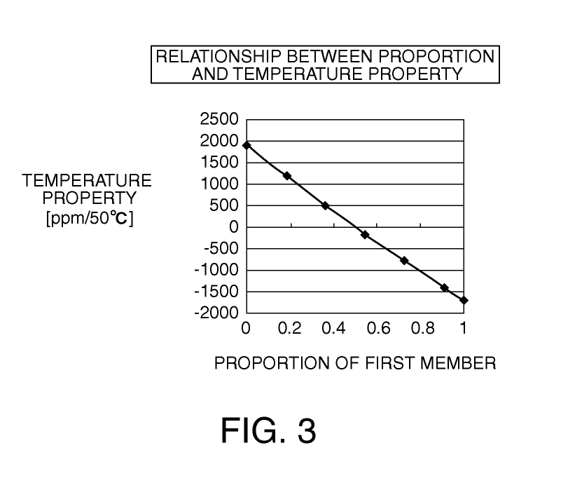

FIG. 3 is a graph showing the relationship between the proportion of the first member and temperature property. The horizontal axis of the graph indicates the proportion of the length of the first member among the first and second members which constitute the supporting column 36, and the vertical axis indicates temperature property (ppm/50° C.). The graph shows a case where the thermal expansion coefficient of the first member is lower than that of a quartz crystal. As shown in the graph, the temperature property is 2000 (ppm/50° C.) when the proportion of the first member is 0, and the temperature property tends to decrease as the proportion of the first member increases. Moreover, the proportion of the length of the first member is about 0.4 to 0.6 when the temperature property is in the optimal range of ±500 (ppm/50° C.)

The pressure sensing device 40 and the supporting member 34 of the present embodiment are formed so that they have the same thermal expansion coefficient by adjusting the proportion of the lengths of the first and second members based on the relationship between the temperature property and the proportion of the first member. Moreover, the pressure sensing device 40 and the supporting member 34 have the same proportion of the amounts of expansion and contraction in the detection axis direction due to a change in temperature. Accordingly, in response to expansion and contraction in the detection axis direction due to a change in temperature, the pressure sensing device 40 receives small thermal deformation from the supporting member 34.

However, there is a case in which it is difficult to form the first and second members so as to have the set proportion of the lengths due to manufacturing errors so that the supporting member 34 and the pressure sensing device 40 have the same thermal expansion coefficient.

In the following description, the allowable margin of error of the first and second members constituting the supporting column 36 of the supporting member 34 will be discussed.

For pressure sensors, a measurable pressure range is determined. When the pressure sensing device 40 of the pressure sensor 10 is a quartz crystal vibrator, if a contraction ratio of the quartz crystal vibrator is γ under the maximum pressure value (hereinafter Pmax) applied to the pressure sensor, and the length of the quartz crystal vibrator is L, the quartz crystal vibrator is designed so that the quartz crystal vibrator is contracted by an amount of γL.

In a general hydraulic pressure sensor, the temperature property after temperature correction is about 0.05% Pmax. In the following description, a case in which a target temperature property of the pressure sensor 10 of the present embodiment is set to 0.025% or less Pmax in order to realize more superior precision than the general hydraulic pressure sensor will be described.

In a frequency-variable pressure sensor, basically, temperature correction is performed using a temperature sensor. Through the temperature correction, the temperature property can be decreased by a ratio of about 1/100. Therefore, in order to realize 0.025% Pmax after correction, it is necessary to obtain a temperature property of 2.5% Pmax or less before correction.

Moreover, when the influence of thermal expansion of a pressure sensor is set to 2.5% Pmax or less within the temperature range of 0° C. to 50° C., a change in length X corresponding to a temperature property of 2.5% Pmax is obtained can be expressed by Expression (1) below.

100:2.5=γL:X (1)

From the relation of Expression (1), X=0.025×γ×L.

Therefore, it is necessary to limit the change in length to 0.025γL or less within the temperature range of 0° C. to 50° C.

The stainless steel used for the supporting member in the present embodiment can make its thermal expansion identical to that of the pressure sensing device by strictly adjusting the proportion of the length of the member so that the supporting member has the same thermal expansion coefficient as the pressure sensing device.

However, if there is an error Δ in the proportion of the lengths of the first and second members constituting the supporting member, thermal expansion may occur.

If the difference in thermal expansion at that time is Y, it can be expressed by Y=50×Δ×(α1−α2) in the temperature range of 0° C. to 50° C.

Here, α1 and α2 indicate the thermal expansion coefficients of two stainless members (the first and second members) formed of different materials.

Moreover, if the difference in thermal expansion Y in the temperature range of 0° C. to 50° C. is smaller than the change in length X corresponding to a temperature property of 2.5% Pmax, namely Y<X, it is possible to realize superior precision.

In this case, the relation Y<X can be expressed by Expression (2) below.

Y=50×α×(α−α2)<X=0.025×γ×L (2)

In this way, the error Δ in the proportion of the lengths of the first and second members can be expressed by Expression (3) below.

Δ<0.0005×γ×L/(α−α2) (3)

As an example, if γ=0.001, α1=16×10⁻⁶ (ppm/° C.), and α2=11×10⁻⁶ (ppm/° C.), the error A in the proportion of the lengths of the first and second members becomes 0.1L. Thus, a structural error of 10% is allowed with respect to the total length L of the quartz crystal vibrator.

Next, a method of manufacturing the pressure sensor 10 according to the first embodiment will be described. First, the diaphragm 24 is connected to the ring portion 16, and the supporting block 30 and the supporting member 34 are connected to predetermined positions of the diaphragm 24. As the connecting method, a fixing agent such as an adhesive agent, or laser welding, arc welding, soldering, and the like can be used. Moreover, the first base portion 40a of the pressure sensing device 40 is connected to the side surface of the supporting block 30, and the second base portion 40b is connected to the supporting member 34. Then, the supporting shaft 18 is fixed by inserting it into the hole 16a of the ring portion 16, and the other end of the supporting shaft 18 of which one end thereof has been inserted into the ring portion 16 is fixed by inserting it into the hole 14c of the flange portion 14. Moreover, the portions of the hermetic terminals (not shown) disposed inside the housing 12 are electrically connected to the electrode portions (not shown) of the pressure sensing device 40 by the wires (not shown). In this case, the portions of the hermetic terminals (not shown) disposed outside the housing 12 are connected to the IC (not shown). Finally, the side surfaces 20 are inserted from the side of the ring portion 16 so as to be bonded to the outer periphery of the flange portion 14 and the outer periphery 16b of the ring portion 16. In this way, the housing 12 is formed, and the pressure sensor 10 is manufactured. When the pressure sensor 10 is used as a pressure sensor that measures absolute pressure with reference to vacuum, the pressure sensor 10 may be assembled in vacuum without forming the air inlet opening 14d.

When measuring fluid pressure with reference to atmosphere, the central portion 24a of the diaphragm 24 is displaced toward the inner side of the housing 12 if the fluid pressure is lower than atmospheric pressure. In contrast, the central portion 24a is displaced toward the outer side of the housing 12 if the fluid pressure is higher than atmospheric pressure. Moreover, when the central portion 24a of the diaphragm 24 is displaced toward the outer side of the housing 12, the pressure sensing device 40 receives tensile stress from the central portion 24a and the supporting member 34. In contrast, when the central portion 24a is displaced toward the inner side of the housing 12, the pressure sensing device 40 receives compressive stress from the central portion 24a and the supporting member 34. Furthermore, when there is a change in temperature of the pressure sensor 10, the housing 12, the diaphragm 24, the supporting member 34, the pressure sensing device 40, and the like constituting the pressure sensor 10 will be expanded and contracted in accordance with their thermal expansion coefficient. However, as described above, since both ends in the detection axis direction of the pressure sensing device 40 are connected to the side of the diaphragm 24, the thermal deformation resulting from the expansion and contraction in the Z-axis direction of the housing 12 is suppressed.

Moreover, when the pressure sensing device 40 and the diaphragm 24 are expanded and contracted in a direction (X-axis direction) vertical to the detection axis due to a change in temperature resulting from a difference in the thermal expansion coefficients thereof, the pressure sensing device 40 receives thermal deformation from the diaphragm 24 through the supporting member 34. However, since the second member 36b constituting the supporting member 34 is formed of the same material as the diaphragm 24, the pressure sensor 10 is capable of decrease the amount of thermal deformation applied to the pressure sensing device 40 to thereby decrease the error in the pressure values due to a change in temperature.

### Second Embodiment

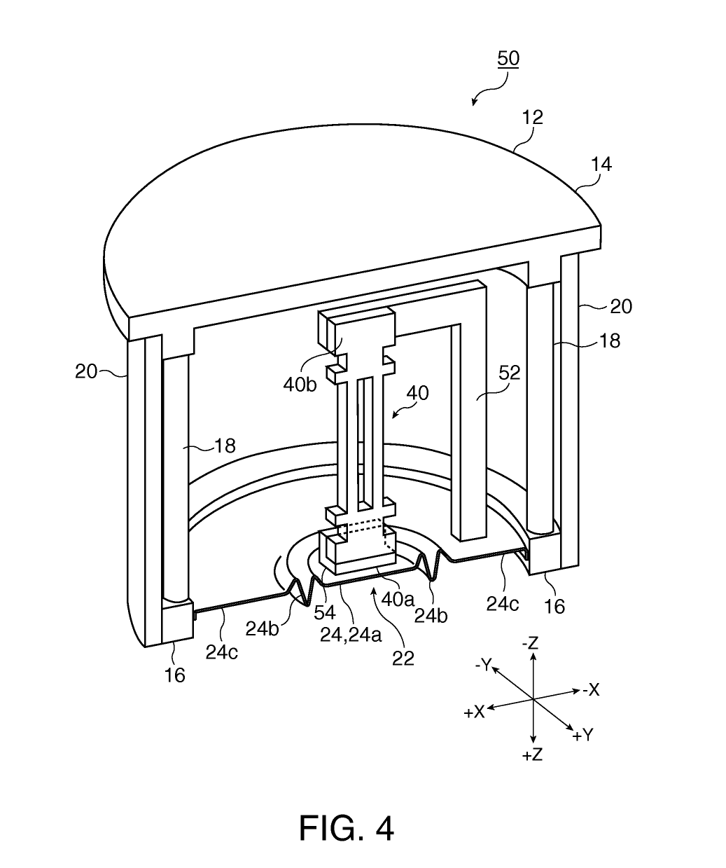

FIG. 4 is a perspective cross-sectional view of a pressure sensor according to a second embodiment, taken along the XZ plane.

A pressure sensor 50 according to the second embodiment basically has the same configuration as the pressure sensor 10 of the first embodiment, except for the supporting member and the supporting block. The other constituent elements are the same as those of the first embodiment and will be denoted by the same reference numerals, and detailed description thereof will be omitted. The pressure sensor 50 of the second embodiment includes a supporting member 52 and a supporting block 54 which are formed of different materials. Specifically, the supporting member 52 has the same shape and the same arrangement as those of the supporting member 34 of the first embodiment but is formed by a single member. Moreover, the supporting block 54 is formed approximately in an L shape between the first base portion 40a of the pressure sensing device 40 and the central portion 24a of the diaphragm 24. Among the supporting member 52 and the supporting block 54, the supporting member 52 is formed of the same material as the diaphragm 24, That is, the supporting member 52 is formed of a material having excellent corrosion resistance such as metal (for example, stainless steel) or ceramics. Moreover, the supporting block 54 is formed of a material having a lower thermal expansion coefficient than the pressure sensing device 40 when the material of the diaphragm 24 has a higher thermal expansion coefficient than the material of the pressure sensing device 40, and is formed of a material having a higher thermal expansion coefficient than the pressure sensing device 40 when the material of the diaphragm 24 has a lower thermal expansion coefficient than the material of the pressure sensing device 40.

In the pressure sensor 50 according to the second embodiment, since both ends (the first and second base portions 40a and 40b) in the longitudinal direction of the pressure sensing device 40 are finally connected to the side of the diaphragm 24, it is possible to suppress thermal deformation transmitted to the pressure sensing device 40 from the housing 12. Furthermore, the pressure sensing device 40, the supporting member 52, and the supporting block 54 are formed so that they have the same thermal expansion coefficient by adjusting the proportion of the length of the supporting block 54. Therefore, the pressure sensing device 40, the supporting member 52, and the supporting block 54 have the same proportion of the amounts of expansion and contraction in the detection axis direction due to a change in temperature. Accordingly, in response to expansion and contraction in the detection axis direction due to a change in temperature, the pressure sensing device 40 receives small thermal deformation from the supporting member 52. Moreover, since the supporting member 52 is formed of the same material as the pressure receiving member, thermal deformation does not occur between the pressure receiving member and a portion extending in a direction vertical to the detection axis direction of the pressure sensing device, and the pressure sensing device does not receive the thermal deformation.

### Third Embodiment

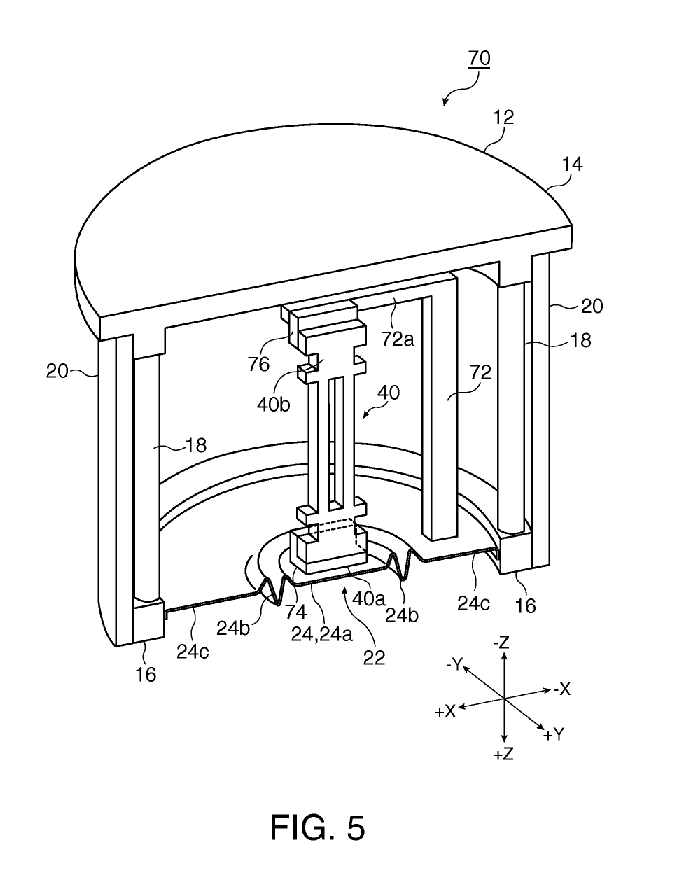

FIG. 5 is a perspective cross-sectional view of a pressure sensor according to a third embodiment, taken along the XZ plane.

A pressure sensor 70 according to the third embodiment basically has the same configuration as the pressure sensor 10 of the first embodiment, except for the supporting member and the supporting block. The other constituent elements are the same as those of the first embodiment and will be denoted by the same reference numerals, and detailed description thereof will be omitted. The pressure sensor 70 of the third embodiment includes a supporting member 72 and first and second supporting blocks 74 and 76, which are formed of different materials. Specifically, the supporting member 72 has the same shape as that of the supporting member 34 of the first embodiment but is formed by a single member. Moreover, the first and second supporting blocks 74 and 76 are formed of the same material but different from that of the supporting member 72. The first supporting block 74 is formed approximately in an L shape between the first base portion 40a of the pressure sensing device 40 and the central portion 24a of the diaphragm 24. The second supporting block 76 is formed between the second base portion 40b of the pressure sensing device 40 and a supporting portion 72a of the supporting member 72. Among the supporting member 72 and the first and second supporting blocks 74 and 76, the supporting member 72 is formed of the same material as the diaphragm 24, That is, the supporting member 72 is formed of a material having excellent corrosion resistance such as metal (for example, stainless steel) or ceramics. Moreover, the first and second supporting blocks 74 and 76 are formed of a material having a lower thermal expansion coefficient than the pressure sensing device 40 when the material of the diaphragm 24 has a higher thermal expansion coefficient than the material of the pressure sensing device 40, and are formed of a material having a higher thermal expansion coefficient than the pressure sensing device 40 when the material of the diaphragm 24 has a lower thermal expansion coefficient than the material of the pressure sensing device 40.

In the pressure sensor 70 according to the third embodiment, since both ends (the first and second base portions 40a and 40b) in the longitudinal direction of the pressure sensing device 40 are finally connected to the side of the diaphragm 24, it is possible to suppress thermal deformation transmitted to the pressure sensing device 40 from the housing 12. Furthermore, the pressure sensing device 40, the supporting member 72, and the first and second supporting blocks 74 and 76 are formed so that they have the same thermal expansion coefficient by adjusting the proportion of the lengths of the first and second supporting blocks 74 and 76. Therefore, the pressure sensing device 40, the supporting member 72, and the first and second supporting blocks 74 and 76 have the same proportion of the amounts of expansion and contraction in the detection axis direction due to a change in temperature. Accordingly, in response to expansion and contraction in the detection axis direction due to a change in temperature, the pressure sensing device 40 receives small thermal deformation from the supporting member 72. Moreover, since the supporting member 72 is formed of the same material as the pressure receiving member, thermal deformation does not occur between the pressure receiving member and a portion extending in a direction vertical to the detection axis direction of the pressure sensing device, and the pressure sensing device does not receive the thermal deformation.

### Fourth Embodiment

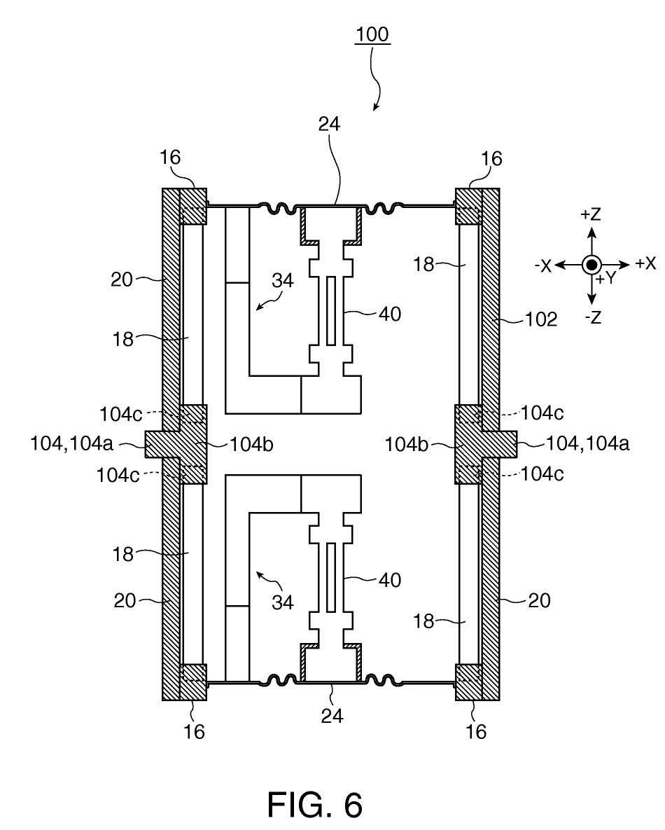

FIG. 6 is a schematic view of a pressure sensor according to a fourth embodiment. A pressure sensor 100 according to the fourth embodiment has a configuration in which another set of the diaphragm 24, the pressure sensing device 40, and the supporting member 34 are arranged in a housing 102. The pressure sensor 100 shown in FIG. 6 uses two pressure sensors 10 of the first embodiment. That is, the pressure sensor 100 has a configuration in which two pressure sensors 10 without the flange portion of the first embodiment are bonded to each other using a flange portion 104 configured to be connected to both sides of the supporting shafts 18 that constitute two pressure sensors 10, whereby one housing 102 is formed. The flange portion 104 includes an outer peripheral portion 104a that is connected to the end portions of the side surfaces 20 and an inner peripheral portion 104b that is formed on the inner side of the outer peripheral portion 104a to be concentric to the ring portion 16, has the same diameter as the ring portion 16, and is connected to the inner side surfaces of the side surfaces 20. Moreover, the flange portion 104 has holes 104c which are formed in the end portions in the Z-axis direction of the inner peripheral portion 104b so that the supporting shafts 18 are inserted therein. In the pressure sensor 100 shown in FIG. 6, the upper and lower half parts of the pressure sensor 100 with the flange portion 104 disposed therebetween can be assembled independently.

Although the pressure sensor 100 of the fourth embodiment measures the pressure values associated with two diaphragms independently, the pressure sensor 100 can be used as a differential pressure sensor which suppresses pressure errors due to the influence of temperature difference or the like since the internal environment of the housing 102 is the same. In this case, the inside of the housing 102 may be vacuum-sealed and may be opened to the atmosphere.

The entire disclosure of Japanese Patent Application No. 2010-200055, filed Sep. 7, 2010 is expressly incorporated by reference herein.

1. A pressure sensor comprising:
a container;
a pressure receiving member which constitutes a part of the container and is displaced toward the inner side or the outer side of the container in response to a force;
a supporting member which extends from a peripheral portion of the pressure receiving member in parallel to the displacement direction of the pressure receiving member, and in which an end portion thereof is bent toward a central portion of the pressure receiving member; and
a pressure sensing device which has a pressure sensing portion and first and second base portions respectively connected to both ends of the pressure sensing portion, in which an arrangement direction of the first and second base portions is parallel to the displacement direction of the pressure receiving member, the first base portion is fixed to the central portion of the pressure receiving member, and the second base portion is fixed to the supporting member,
wherein the supporting member includes two or more members which are formed of different materials and connected in the displacement direction, and the proportion of the lengths of the two or more members is adjusted so that the supporting member has the same thermal expansion coefficient as the pressure sensing device.

2. The pressure sensor according to claim 1,
wherein one of the two or more members is formed of the same material as the pressure receiving member, and
wherein the other member is formed of a material having a lower thermal expansion coefficient than the pressure sensing device when the thermal expansion coefficient of the material of the pressure receiving member is higher than the thermal expansion coefficient of the material of the pressure sensing device and is formed of a material having a higher thermal expansion coefficient than the pressure sensing device when the thermal expansion coefficient of the material of the pressure receiving member is lower than the thermal expansion coefficient of the material of the pressure sensing device.

3. The pressure sensor according to claim 1,
wherein the pressure sensing device is formed of a quartz crystal, and the pressure receiving member is formed of stainless steel.

4. A pressure sensor comprising:
a container;
a pressure receiving member which constitutes a part of the container and is displaced toward the inner side or the outer side of the container in response to a force;
a supporting member which extends from a peripheral portion of the pressure receiving member in parallel to the displacement direction of the pressure receiving member, and in which an end portion thereof is bent toward a central portion of the pressure receiving member; and
a pressure sensing device which has a pressure sensing portion and first and second base portions respectively connected to both ends of the pressure sensing portion, in which an arrangement direction of the first and second base portions is parallel to the displacement direction of the pressure receiving member, the first base portion is fixed to a supporting block of the pressure receiving member, and the second base portion is fixed to the supporting member,
wherein the supporting member and the supporting block include two or more members which are formed of different materials, and the proportion of the lengths of the two or more members is adjusted so that the supporting member and the supporting block have the same thermal expansion coefficient as the pressure sensing device.

5. The pressure sensor according to claim 1,
wherein another set of the pressure receiving member, the pressure sensing device, and the supporting member are arranged in the container.

6. The pressure sensor according to claim 3,
wherein another set of the pressure receiving member, the pressure sensing device, and the supporting member are arranged in the container.

7. The pressure sensor according to claim 4,
wherein another set of the pressure receiving member, the pressure sensing device, and the supporting member are arranged in the container.

8. The pressure sensor according to claim 2,
wherein the pressure sensing device is formed of a quartz crystal, and the pressure receiving member is formed of stainless steel.

9. The pressure sensor according to claim 8,
wherein another set of the pressure receiving member, the pressure sensing device, and the supporting member are arranged in the container.

10. The pressure sensor according to claim 2,
wherein another set of the pressure receiving member, the pressure sensing device, and the supporting member are arranged in the container.
